(19) United States
(12) Patent Application Publication
(10) Pub. No.: US 2025/0219519 A1
(43) Pub. Date: Jul. 3, 2025

(54) ROTATION ANGLE CALCULATION SYSTEM, ROTATION ANGLE CALCULATION METHOD, AND STORAGE MEDIUM

(71) Applicant: DENSO CORPORATION, Kariya-city (JP)

(72) Inventors: Tomohiro AOYAMA, Kariya-city (JP); Norihiro SUGIMOTO, Kariya-city (JP)

(73) Assignee: DENSO CORPORATION, Kariya-city (JP)

(21) Appl. No.: 19/082,434

(22) Filed: Mar. 18, 2025

Related U.S. Application Data
(63) Continuation of application No. PCT/JP2023/028934, filed on Aug. 8, 2023.

(30) Foreign Application Priority Data
Oct. 7, 2022 (JP) 2022-162725

(51) Int. Cl. H02K 29/08; H02K 21/14; H02P 23/00; H02P 25/026

(52) U.S. Cl. CPC H02K 29/08; H02K 21/14; H02P 23/0077; H02P 25/026; H02P 2207/055

(57) ABSTRACT

The rotation angle calculation device includes: an acquisition unit that acquires detection results of a leakage flux generated by a permanent magnet, from each of three detection elements, the permanent magnet being included in a detection target of the rotation angle, the three detection elements being arranged at positions offset by 120 degrees from each other in electrical angle relative to the permanent magnet, a generation unit that generates orthogonal component signals, each of the orthogonal component signals representing one of two orthogonal components representing the strength of the leakage flux, based on the three detection results, and a calculation unit that calculates the rotation angle of the detection target based on the orthogonal component signals.

### CROSS-REFERENCE TO RELATED APPLICATIONS

The present application is a continuation application of International Application No. PCT/JP2023/028934, filed on Aug. 8, 2023, which claims priority to Japanese Application No. 2022-162725, filed on Oct. 7, 2022. The contents of these applications are incorporated herein by reference in their entirety.

### BACKGROUND

### 1. Technical Field

The present disclosure relates to a rotation angle calculation system, a rotation angle calculation method, and a storage medium storing a rotation angle calculation program for calculating the rotation angle of a detection target.

### 2. Related Art

JP2005323490A discloses a permanent magnet synchronous motor device in which each of two Hall elements detecting magnetic flux generated by the permanent magnet are positioned at a rotational electric angle greater than 0 degrees and less than 180 degrees with respect to the rotor in which the permanent magnet is installed. The permanent magnet synchronous motor device generates a current to excite windings that drive a rotor in response to the signals detected by the Hall elements.

The permanent magnet synchronous motor device is equipped with a controller controlling the current that excites the windings. The controller controls the current that excites the windings according to the signal detected by the Hall elements. This suppresses the torque ripple.

### SUMMARY

The rotation angle calculation system in accordance with the first aspect of this disclosure includes: a rotation angle calculation device that calculates a rotation angle of a detection target, and a motor comprising a stator around which windings are wound and a rotor in which a permanent magnet is installed. The rotation angle calculation device includes: an acquisition unit that acquires detection results of a leakage flux generated by a permanent magnet, from each of three detection elements, the permanent magnet being included in a detection target of the rotation angle, the three detection elements being arranged at positions offset by 120 degrees with each other in electrical angle relative to the permanent magnet, a generation unit that generates orthogonal component signals, each of the orthogonal component signals representing one of two orthogonal components representing the strength of the leakage flux, based on the three detection results, and a calculation unit that calculates the rotation angle of the detection target based on the orthogonal component signals. Each of the three detection elements is positioned at a location where the leakage flux generated by the permanent magnet installed between the stator and the rotor can be detected. A length M of the permanent magnet in an axial direction of the motor is represented by S+2A≤M≤1.3S, where S is a length of the stator in the axial direction of the motor, and A is a length of a gap in a radial direction of the motor between the permanent magnet and the stator.

The method for calculating the angle of rotation in accordance with the second aspect of the present disclosure includes: acquiring detection results of a leakage flux generated by a permanent magnet, from each of three detection elements, the permanent magnet being included in a detection target of the rotation angle, the detection target being a motor comprising a stator around which windings are wound and a rotor in which a permanent magnet is installed, the three detection elements being arranged at positions offset by 120 degrees from each other in electrical angle relative to the permanent magnet, generating orthogonal component signals, each of the orthogonal component signals representing one of two orthogonal components representing the strength of the leakage flux, based on the three detection results, and calculating the rotation angle of the detection target based on the orthogonal component signals. Each of the three detection elements is positioned at a location where the leakage flux generated by the permanent magnet installed between the stator and the rotor can be detected. A length M of the permanent magnet in an axial direction of the motor is represented by S+2A≤M≤1.3S, where S is a length of the stator in the axial direction of the motor, and A is a length of a gap in a radial direction of the motor between the permanent magnet and the stator.

A non-transitory computer-readable storage medium in accordance with the third aspect of the present disclosure stores a rotation angle calculation program. The rotation angle calculation program causes at least one processor to perform: acquiring detection results of a leakage flux generated by a permanent magnet, from each of three detection elements, the permanent magnet being included in a detection target of the rotation angle, the detection target being a motor comprising a stator around which windings are wound and a rotor in which a permanent magnet is installed, the three detection elements being arranged at positions offset by 120 degrees with each other in electrical angle relative to the permanent magnet, generating orthogonal component signals, each of the orthogonal component signals representing one of two orthogonal components representing the strength of the leakage flux, based on the three detection results, and calculating the rotation angle of the detection target based on the orthogonal component signals. Each of the three detection elements is positioned at a location where the leakage flux generated by the permanent magnet installed between the stator and the rotor can be detected. A length M of the permanent magnet in an axial direction of the motor is represented by S+2A≤M≤1.3S, where S is a length of the stator in the axial direction of the motor, and A is a length of a gap in a radial direction of the motor between the permanent magnet and the stator.

### BRIEF DESCRIPTION OF THE DRAWING

The above and other objects, features and advantages of the present disclosure will become clearer with the following detailed description with reference to the accompanying drawings. The drawings are:

FIG. 1 is a schematic diagram of an embodiment of a rotation angle calculation system;

FIG. 2 is a block diagram showing an example of the hardware configuration of the rotation angle calculation device according to an embodiment;

FIG. 3 is a block diagram showing an example of the functional configuration of the rotation angle calculation device according to an embodiment;

FIG. 4 is a graph showing an example of detection results for an electrical angle;

FIG. 5 is a schematic diagram showing an example of synthesized detection results;

FIG. 6 is a graph showing an example of the synthesized detection results for the electrical angle;

FIG. 7 is a flowchart showing an example of the rotation angle calculation method according to an embodiment;

FIG. 8 is a front view of an example configuration of a permanent magnet synchronous motor (SPM);

FIG. 9 illustrates the Hall element arrangement according to an embodiment;

FIG. 10 is a front view of an example configuration of an embedded permanent magnet synchronous motor (IPM) according to a first modification;

FIG. 11 is a front view of an example configuration of an outer rotor type permanent magnet synchronous motor for according to a second modification;

FIG. 12 is a front view of an example configuration of an axial-gap permanent magnet synchronous motor for according to a third modification.

### DETAILED DESCRIPTION OF THE PREFERRED EMBODIMENTS

Each of the waveform of signals indicating a strength of the magnetic flux detected by each of the two Hall elements should be a first-order SIN wave according to the electric angle. The more the waveform of the signal deviates from the first-order SIN wave, the more errors will occur in calculation of the rotation angle. Specifically, when the signals detected by the two Hall elements are used to generate two orthogonal component signals according to the electric angle, noise may be included in the signals. As a result, an error may occur between a calculated result of the rotation angle of a detection target and the actual rotation angle of the detection target. This disclosure aims to provide a rotation angle calculation device, a rotation angle calculation system, a rotation angle calculation method, and a rotation angle calculation program that can suppress errors between the calculation result of the rotation angle of the detection target and the actual rotation angle when generating signals of two orthogonal components according to the electric angle.

The rotation angle calculation system in accordance with the first aspect of this disclosure includes: a rotation angle calculation device that calculates a rotation angle of a detection target, and a motor comprising a stator around which windings are wound and a rotor in which a permanent magnet is installed. The rotation angle calculation device includes: an acquisition unit that acquires detection results of a leakage flux generated by a permanent magnet, from each of three detection elements, the permanent magnet being included in a detection target of the rotation angle, the three detection elements being arranged at positions offset by 120 degrees from each other in electrical angle relative to the permanent magnet, a generation unit that generates orthogonal component signals, each of the orthogonal component signals representing one of two orthogonal components representing the strength of the leakage flux, based on the three detection results, and a calculation unit that calculates the rotation angle of the detection target based on the orthogonal component signals. Each of the three detection elements is positioned at a location where the leakage flux generated by the permanent magnet installed between the stator and the rotor can be detected. A length M of the permanent magnet in an axial direction of the motor is represented by S+2A≤M≤1.3S, where S is a length of the stator in the axial direction of the motor, and A is a length of a gap in a radial direction of the motor between the permanent magnet and the stator.

The method for calculating the angle of rotation in accordance with the second aspect of the present disclosure includes: acquiring detection results of a leakage flux generated by a permanent magnet, from each of three detection elements, the permanent magnet being included in a detection target of the rotation angle, the detection target being a motor comprising a stator around which windings are wound and a rotor in which a permanent magnet is installed, the three detection elements being arranged at positions offset by 120 degrees from each other in electrical angle relative to the permanent magnet, generating orthogonal component signals, each of the orthogonal component signals representing one of two orthogonal components representing the strength of the leakage flux, based on the three detection results, and calculating the rotation angle of the detection target based on the orthogonal component signals. Each of the three detection elements is positioned at a location where the leakage flux generated by the permanent magnet installed between the stator and the rotor can be detected. A length M of the permanent magnet in an axial direction of the motor is represented by S+2A≤M≤1.3S, where S is a length of the stator in the axial direction of the motor, and A is a length of a gap in a radial direction of the motor between the permanent magnet and the stator.

A non-transitory computer-readable storage medium in accordance with the third aspect of the present disclosure stores a rotation angle calculation program. The rotation angle calculation program causes at least one processor to perform: acquiring detection results of a leakage flux generated by a permanent magnet, from each of three detection elements, the permanent magnet being included in a detection target of the rotation angle, the detection target being a motor comprising a stator around which windings are wound and a rotor in which a permanent magnet is installed, the three detection elements being arranged at positions offset by 120 degrees from each other in electrical angle relative to the permanent magnet, generating orthogonal component signals, each of the orthogonal component signals representing one of two orthogonal components representing the strength of the leakage flux, based on the three detection results, and calculating the rotation angle of the detection target based on the orthogonal component signals. Each of the three detection elements is positioned at a location where the leakage flux generated by the permanent magnet installed between the stator and the rotor can be detected. A length M of the permanent magnet in an axial direction of the motor is represented by S+2A≤M≤1.3S, where S is a length of the stator in the axial direction of the motor, and A is a length of a gap in a radial direction of the motor between the permanent magnet and the stator.

According to the present disclosure, when generating signals of two orthogonal components according to the electric angle, the error between the calculated result of the rotation angle of the detection target and the actual rotation angle can be suppressed.

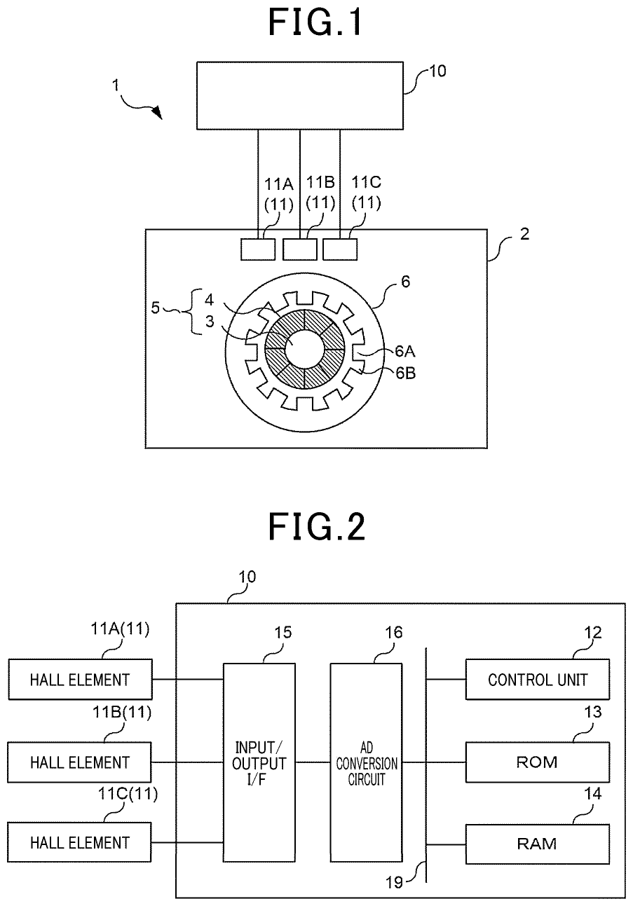

The following is a detailed description of an embodiment for implementing the present disclosure with reference to the drawings. FIG. 1 shows an example of an embodiment of a rotation angle calculation system.

### (Configuration of Rotation Angle Calculation System)

As shown in FIG. 1, the rotation angle calculation system 1 may have a permanent magnet synchronous motor 2 and a rotation angle calculation device 10 that calculates the rotation angle of the motor 2.

Motor 2 includes a rotor 5 and a stator 6. The rotor 5 includes a rotor core 3 and permanent magnets 4.

For example, motor 2 may be an inner rotor permanent magnet synchronous motor. The rotor 5 is installed inside the stator 6 in the radial direction. Each of the permanent magnets 4 is fixed to the rotor core 3. The magnetic fields of the adjacent permanent magnets 4 are in opposite directions. The stator 6 has teeth 6A around which windings, not shown, are wound respectively, and slots 6B configured between the teeth 6A. In the embodiment, the motor 2 is a permanent magnet synchronous motor. In the stator 6, the permanent magnets 4 with 8 poles and the stator 6B with 12 slots (the part accommodating the windings). Alternatively, the permanent magnets 4 may have 4 poles and the slot 6B may have 8 slots. The number of the poles of the permanent magnets 4 and the number of the slots 6B may be any number.

The rotation angle calculation device 10 has Hall element 11A, Hall element 11B, and Hall element 11C. In the following, when the respective Hall elements 11 are distinguished, they are described as Hall element 11A, Hall element 11B, and Hall element 11C, and when not distinguished, they are described as Hall elements 11 or Hall element 11. The Hall element 11 is an example of the “detection element”.

Each of the Hall elements 11 is positioned inside the motor 2 at a location where the leakage magnetic flux generated by the permanent magnet 4 can be detected. The three Hall elements 11 are installed for each pole of the permanent magnets 4. Each of the Hall elements 11 outputs a signal indicating a strength of a leakage magnetic flux as a detection result. The Hall elements 11 are arranged at positions offset by 120 degrees from each other in electrical angle. When the motor 2 includes multiple permanent magnets 4, the arrangement pitch of each Hall element 11 is expressed by the following formula referencing one Hall element 11.

$$d = ( s \times 120 ° / p ) + ( n \times 360 ° / p ) \qquad ( 1 )$$

Above “d” is the pitch of the other Hall elements 11 relative to the reference one, “p” is the pole logarithm of the permanent magnets 4. “s” is an identifier to identify each of the Hall elements 11 for one permanent magnet 4. “s” is any one of 1 or 2. “n” is an identifier to identify each of the permanent magnets 4. “n” is an integer from 0 to p−1.

For example, when the motor 2 is equipped with 8 permanent magnets with 4 poles, each of the Hall elements 11 is arranged along the circumferential direction of the motor 2 with intervals of 15 degrees in the machine angle. The form in which the Hall elements 11A, the Hall element 11B, and the Hall element 11C detects signal respectively are described below.

The rotation angle calculation device 10 generates a SIN signal and a COS signal based on three-phase signals detected by each of the Hall element 11A, the Hall element 11B, and the Hall element 11C. The rotation angle calculation device 10 calculates the rotation angle of the motor 2 based on the SIN signal and the COS signal; each of the SIN signal and the COS signal is an example of the “orthogonal component signal”.

### (Configuration of Rotation Angle Calculation Device)

Next, explanations of the hardware configuration of the rotation angle calculation device 10 are given with reference to FIG. 2. FIG. 2 is a block diagram showing an example of the hardware configuration of the rotation angle calculation device of the embodiment.

As shown in FIG. 2, for example, the rotation angle calculation device 10 may have the Hall element 11, a control unit 12, ROM (Read Only Memory) 13, RAM (Random Access Memory) 14, an input/output interface (hereinafter referred to as “INPUT/OUTPUT I/F”) 15, and an analog-to-digital conversion circuit (“AD conversion circuit”) 16. Each of the control unit 12, the ROM 13, the RAM 14, and the AD conversion circuit 16 is interconnected by a bus 19.

The Hall element 11 is a sensor that detects the leakage magnetic flux of the permanent magnet 4. The control unit 12 supervises and controls the overall rotation angle calculation device 10. The ROM 13 stores various programs and data, etc. The RAM 14 is a memory used as a work area when various programs are executed. The control unit 12 performs the process of calculating the rotation angle of the detection target by downloading the programs stored in the ROM 13 and copying them to the RAM 14 and executing them.

The input/output I/F 15 is connected to the Hall element 11 and the AD conversion circuit 16. The input/output I/F 15 outputs the three-phase signals input from the Hall element 11A, the Hall element 11B, and the Hall element 11C respectively to the AD conversion circuit 16.

The AD conversion circuit 16 converts the three-phase analog signals output by the input/output I/F 15 into digital signals and outputs them to the control unit 12.

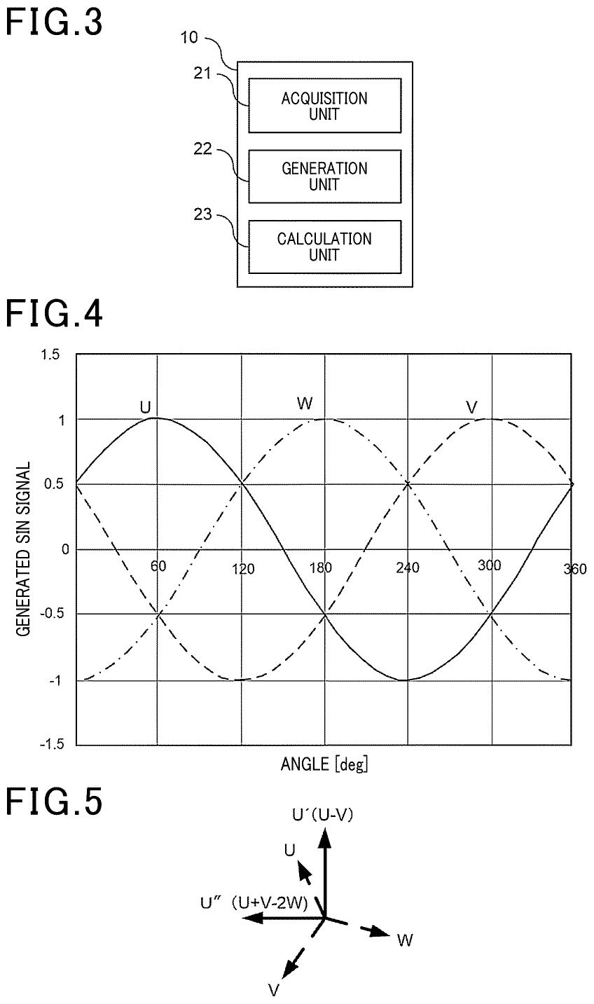

Next, explanations of the functional configuration of the rotation angle calculation device 10 are given with reference to FIG. 3. FIG. 3 is a block diagram showing an example of the functional configuration of the rotation angle calculation device 10.

As shown in FIG. 3, for example, the rotation angle calculation device 10 may have an acquisition unit 21, a generation unit 22, and a calculation unit 23.

The acquisition unit 21 acquires digital signals converted from the three-phase analog signals output by the Hall element 11 via the input/output I/F 15 and the AD conversion circuit 16. As shown in FIG. 4, each of the Hall elements 11 may output, for example, three-phase analog signals of phase U, phase V, or phase W. Here, each analog signal has a phase difference of 120 degrees from each other.

The generation unit 22 generates the SIN signal and the COS signal that are orthogonal to each other based on the three-phase digital signals acquired by the acquisition unit 21. Specifically, the generation unit 22 derives the difference between the values of the two signals among the three-phase signals and generates the SIN signal and the COS signal based on the derived difference. The differences between the respective signals are expressed by the following formulas.

$${U}^{′} = U - V \qquad ( 2 )$$

$${V}^{′} = V - W \qquad ( 3 )$$

$${W}^{′} = W - U \qquad ( 4 )$$

$${V}^{″} = {V}^{′} - {W}^{′} \qquad ( 5 )$$

U′ is the difference between the signal of phase U and the signal of phase V, V′ is the difference between the signal of phase V and the signal of phase W, W′ is the difference between the signal of phase W and the signal of phase U, V″ is the difference between the signal of phase V′ and the signal of phase W′.

Equation (5) is expressed by equation (6) using the U, V, and W.

$${V}^{″} = U + V - 2 W \qquad ( 6 )$$

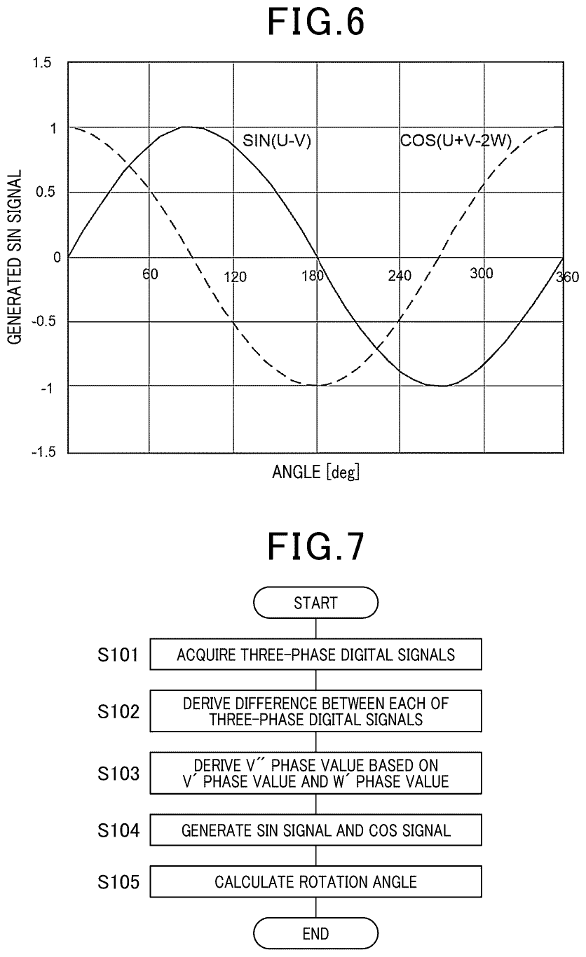

The U′ phase expressed by equation (2) and the V″ phase expressed by equation (6) are orthogonal to each other as shown in FIG. 5. The generation unit 22 normalizes the digital signal of the U′ phase to generate the SIN signal and normalizes the digital signal of the V″ phase to generate the COS signal. According to this process, the orthogonal component signals are generated. FIG. 6 shows an example of the SIN signal corresponding to the U′ phase and the COS signal corresponding to the V″ phase in the analog signal.

The calculation unit 23 calculates the rotation angle of the detection target using the generated SIN signal and COS signal. Specifically, the calculation unit 23 calculates the rotation angle of the detection target by calculating θ=tan⁻¹ (SIN θ/COS θ) based on the value of the SIN signal and the value of the COS signal. θ is the rotation angle of the detection target and tan−1 is the inverse function of tangent. SIN θ is the value of the generated SIN signal and COS θ is the value of the generated COS signal.

Next, explanations of the rotation angle calculation method of the embodiment are given with reference to FIG. 7. FIG. 7 is a flowchart showing an example of the rotation angle calculation method in the embodiment.

In step S101, the rotation angle calculation device 10 acquires the three-phase digital signals, in which the signal detected by the Hall element 11 are converted by the AD conversion circuit 16.

In step S102, the rotation angle calculation unit 10 derives the difference between each of the acquired three-phase digital signals and derives the phase U′ value, the phase V′ value, and the phase W′ value.

In step S103, the rotation angle calculation unit 10 derives the V″ phase value based on the V′ phase value and the W′ phase value.

In step S104, the rotation angle calculation unit 10 normalizes the digital signal value of the U′ phase to generate the SIN signal and normalizes the digital signal value of the V″ phase to generate the COS signal.

In step S105, the rotation angle calculation device 10 calculates the rotation angle of the detection target based on the generated SIN signal and COS signal.

### (Arrangement of Hall Element 11)

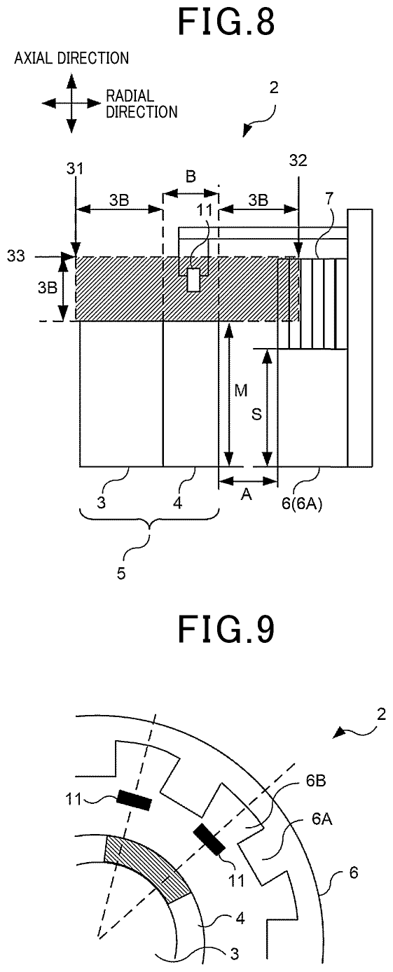

Next, explanations of the arrangement of the Hall element 11 inside the motor 2 of the embodiment are given, with reference to FIG. 8. FIG. 8 is a schematic diagram showing an example of the configuration of the motor 2 of the embodiment. The motor 2 of the embodiment may be, for example, an inner rotor type permanent magnet synchronous motor. The rotor 5 is installed inside the stator 6 in the radial direction.

As shown in FIG. 8, the rotor 5 may include the rotor core 3 at the shaft center and the permanent magnet 4 located outside the rotor core 3 in the radial direction of the motor 2. The stator 6 includes the teeth 6A located outside of the rotor core 3 in the radial direction of the motor 2 and a windings (coil) 7 wound around the teeth 6A. In the motor 2 of the embodiment, the rotor core 3, the permanent magnet 4, and the stator 6 are installed in this order from the center (axis) of the motor 2 to the outside in the radial direction.

The Hall element 11 is positioned at a location where the leakage magnetic flux generated by the permanent magnet 4 can be detected. Specifically, when the length in the radial direction of the permanent magnet 4 is B, the position of the Hall element 11 in the radial direction of the motor 2 is from the position (arrow 31) three times the distance B away from the inner terminal (an example of the “one terminal”) of the permanent magnet 4 to the position (arrow 32) three times the distance B away from the outer terminal (an example of “the other terminal”) of the permanent magnet 4 in the radial direction of the motor 2. This allows leakage flux to be detected. Similarly, the position of the Hall element 11 in the axial direction of the motor 2 is, from the upper terminal (an example of “terminal”) of the permanent magnet 4 to a position (arrow 33) that is three times the distance away from the upper terminal. It is desirable that the position of the Hall element 11 in the axial direction should not exceed the height (axial length) of the windings 7.

In the embodiment, the arrangement of the Hall element 11 for detecting the leakage flux of the permanent magnet 4 is described. In addition to this, the height of the permanent magnet 4 may be determined as follows.

For example, the height (axial length) M of permanent magnet 4 is expressed by equation (7).

$$S + 2 A \leq M \leq 1.3 S \qquad ( 7 )$$

“S” is the height (axial length) of stator 6 (teeth 6A), and “A” is the size of the gap (air gap) between the rotor 5 and the stator 6 in the radial direction.

As expressed by equation (7), the height M of the permanent magnet 4 should be within the range where the lower limit is twice the size of the air gap A plus the height S of the stator 6 (teeth 6A) and the upper limit is 1.3 times the height S of the stator 6 (teeth 6A). By setting the height of the permanent magnet 4 to a value 1.3 times the height S of the stator 6 (teeth 6A), it is possible to place the Hall element 11 higher as the height of the permanent magnet 4 increases. Therefore, it is possible to increase the distance between the Hall element 11 and the teeth 6A (windings 7), the distortion of the magnetic flux by the teeth 6A (windings 7) is reduced, and the accuracy of the detection of the leakage flux by the Hall element 11 is improved.

The Hall element 11 is placed between the mutually adjacent teeth 6A (on top of slot 6B) configured in stator 6. By this, each of the Hall elements 11 is located between the windings (coils) 7. As a result, the distortion of the magnetic flux by the windings (coil) 7 is reduced. FIG. 9 illustrates the arrangement of the Hall elements 11 of the embodiment. FIG. 9 is a top view of the embodiment of a permanent magnet synchronous motor. As shown in FIG. 9, the Hall elements 11 are each desired to be arranged between one of the teeth 6A and the adjacent another tooth 6A in the circumferential direction. By placing the Hall elements 11 between the teeth 6A adjacent to each other, the effect of the magnetic flux generated by the windings (coil) 7 is suppressed.

### (First Modification on the Arrangement of the Hall Elements 11)

The motor 2 in the above embodiment is a Surface Permanent Magnet (SPM) motor in which the permanent magnets 4 are arranged around the rotor core 3. The motor 2 of a first modification is an IPM (Interior Permanent Magnet) motor with permanent magnets 4 embedded in the rotor core 3.

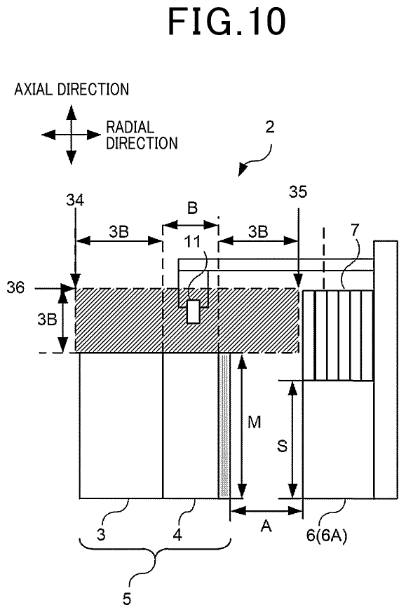

FIG. 10 is a schematic diagram of an example configuration of the first modification. As shown in FIG. 10, in the first modification, the rotor 5 may include the rotor core 3 at the shaft center and the permanent magnet 4 provided inside the rotor core 3. The stator 6 includes the teeth 6A provided outside the rotor core 3 in the radial direction and the windings (coil) 7 wound around the teeth 6A.

The arrangement of the Hall elements 11 in the first modification in the radial direction of the motor 2 is the same as in the above embodiment, with respect to the width (radial length) B of the permanent magnet 4, the position of the Hall element 11 is from the position three times the distance B away from the inner terminal (arrow 34) of the permanent magnet 4 to the position three times the distance B away from the outer terminal of the permanent magnet 4 in the radial direction (arrow 35). The position of the Hall elements 11 in the axial direction of the motor 2 is similarly the position from the upper terminal of the permanent magnet 4 in the axial direction to a distance three times the distance B from the terminal (arrow 36). The position of Hall element 11 in the axial direction of the motor 2 should not exceed the height (axial length) of the windings 7.

When the size of the gap (air gap) between the rotor 5 and stator 6 is A, as expressed by formula (7), the height M of the permanent magnet 4 in the first modification should be within the range where the lower limit is twice the size of the air gap A plus the height S of the stator 6 (teeth 6A) and the upper limit is 1.3 times the height S of the stator 6 (teeth 6A).

### (Second Modification for the Arrangement of the Hall Elements 11)

The motor 2 for the above embodiment is an inner rotor type permanent magnet synchronous motor in which the rotor 5 is installed inside the stator 6 in the radial direction. The motor 2 of a second modification is an outer rotor type permanent magnet synchronous motor in which the rotor 5 is installed outside of the stator 6 in the radial direction.

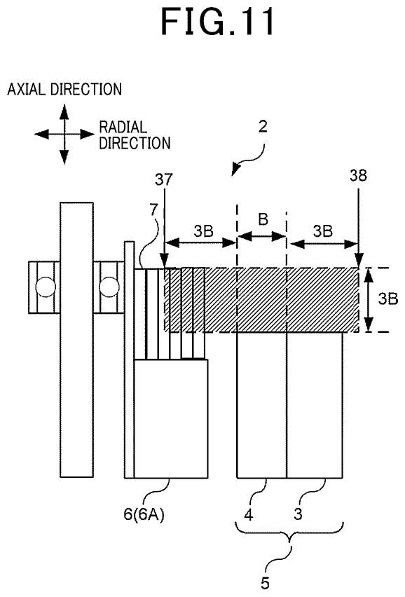

FIG. 11 is a schematic diagram showing an example configuration of the second modification. As shown in FIG. 11, in the motor 2 of the second modification, the rotor 5 may include the rotor core 3 and the permanent magnet 4 installed inside the rotor core 3 in the radial direction. The stator 6 includes the teeth 6A installed inside the rotor core 3 in the radial direction and the windings (coil) 7 wound around the teeth 6A. In other words, in the motor 2 of the second modification, the stator 6, the permanent magnet 4, and the rotor core 3 are installed in this order from the center of the motor 2 toward the outside in the radial direction.

The arrangement of the Hall elements 11 in the second modification in the radial direction of the motor 2 is the same as in the above embodiment, with respect to the width (radial length) B of the permanent magnet, the position of the Hall element 11 is from the position three times the distance B away from the inner terminal (arrow 37) of the permanent magnet 4 to the position three times the distance B away from the outer terminal of the permanent magnet 4 in the radial direction (arrow 38).

### (Third Modification of the Arrangement of the Hall Element 11)

The motor 2 of the above embodiment is a radial-gap type permanent magnet synchronous motor in which permanent magnets 4 are installed so that the direction of the magnetic field faces in the radial direction. The motor 2 of a third modification is an axial-gap type permanent magnet synchronous motor in which the permanent magnets 4 are installed so that the direction of the magnetic field faces the axial direction.

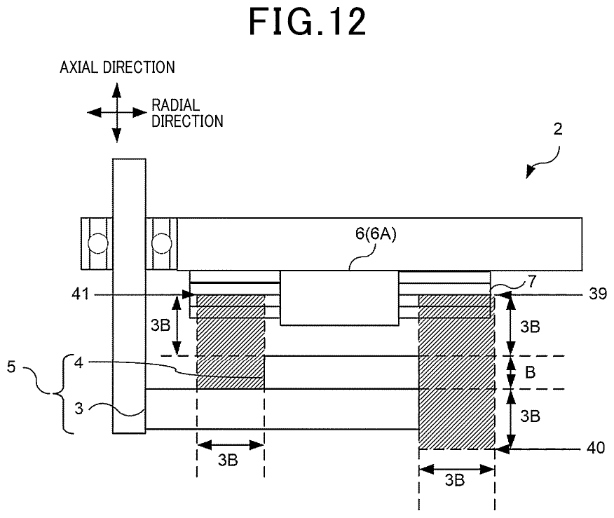

FIG. 12 is a schematic diagram showing an example configuration of the third modification. As shown in FIG. 12, the rotor 5 of the motor 2 of the third modification may include the rotor core 3 of the drive unit and the permanent magnet 4 on the axial upper side of the rotor core 3. The stator 6 includes a teeth 6A on the axial upper side of the rotor core 3 and the windings (coil) 7 wound around the teeth 6A.

The arrangement of the Hall elements 11 in the third modification in the axial direction of the motor 2 is similar to the above embodiment, the position of the Hall element is from the upper terminal of the permanent magnet 4 in the axial direction to a distance three times the distance B from the terminal (arrow 39) to a position three times the distance B from the lower end of the permanent magnet 4 (arrow 40) from the lower terminal of the permanent magnet 4. The position of Hall element 11 in the axial direction of the motor 2 should not exceed the height (axial length) of the winding 7. The Hall element 11 in the radial direction of the motor 2 is similarly positioned from the inner terminal of the permanent magnet 4 to the position three times the distance B from the inner terminal of the permanent magnet 4.

The Hall element 11 can be positioned both inside and outside the stator 6 in the radial direction. When the Hall element 11 is arranged inside the stator 6 in the radial direction, the range of the position of the Hall element 11 is arranged from the axial upper terminal of the permanent magnet 4 to the rotor 5 at a distance of three times B (arrow 41). The position of Hall element 11 in the radial direction of the motor 2 is in the range from the inner terminal of the permanent magnet 4 in the radial direction to a position three times the distance B away from the inner terminal of the permanent magnet 4 in the radial direction.

As explained above, the above embodiment can suppress the error between the calculation result and the actual rotational angle when the signals of two orthogonal components to the electric angle are generated.

Furthermore, according to the above embodiment, by deriving the difference of the detected signals, waveform distortion in the signals can be removed. Furthermore, by deriving the difference of the detected signals, noise received from outside can be removed.

Furthermore, according to the above embodiment, by detecting the leakage flux of the permanent magnet 4 installed in the motor 2, there is no need to install a magnet to detect the rotation angle, and the Hall element 11 can be made smaller.

Furthermore, according to the above embodiment, by increasing the height of the permanent magnet 4, the distance between the stator 6 and the Hall element 11 is increased, and the influence of the magnetic flux by the stator 6 (windings 7) can be suppressed.

Furthermore, according to the above embodiments, magnetic flux from the stator 6 (windings 7) can be suppressed by installing the Hall element 11 between components of the stator 6.

The embodiments described above is in which the rotation angle calculation program is installed in ROM 14 but is not limited to this form. The rotation angle calculation program pertaining to the present disclosure can also be provided in a form recorded on a computer-readable storage medium. For example, the rotation angle calculation program pertaining to the present disclosure may be provided in a form recorded on an optical disk such as CD (Compact Disc)-ROM or DVD (Digital Versatile Disc)-ROM. The rotation angle calculation program for the present disclosure may be provided in the form recorded in semiconductor memory such as USB (Universal Serial Bus) memory and memory cards. The rotation angle calculation device 10 may download the rotation angle calculation program pertaining to the present disclosure from an external device connected to the communication line, which is not shown in the figure, through the communication line.

The control unit and methods described in this disclosure may be realized by a dedicated computer comprising a processor programmed to perform one or more functions embodied by a computer program. Alternatively, the apparatuses and methods described in this disclosure may be realized by a dedicated computer comprising a processor with dedicated hardware logic circuits. Alternatively, the apparatuses and methods described in this disclosure may be realized by one or more dedicated computers comprising a processor executing a computer program in combination with one or more hardware logic circuits. The computer program may also be stored in a computer-readable non-transitory recording medium as instructions to be executed by the computer.

Although this disclosure has been described in accordance with examples, it is understood that this disclosure is not limited to the examples or structures. The present disclosure also encompasses various modifications and transformations within the scope of equality. In addition, various combinations and forms, as well as other combinations and forms including only one element, thereof, also fall within the scope and idea of this disclosure.

The following addendum is disclosed with respect to this disclosure

### (Appendix 1)

A rotation angle calculation device including:
an acquisition unit (21) that acquires detection results of a leakage flux generated by a permanent magnet (4), from each of three detection elements (11), the permanent magnet being included in a detection target of the rotation angle, the three detection elements being arranged at positions offset by 120 degrees from each other in electrical angle relative to the permanent magnet;
a generation unit (22) that generates orthogonal component signals, each of the orthogonal component signals representing one of two orthogonal components representing the strength of the leakage flux, based on the three detection results; and
a calculation unit (23) that calculates the rotation angle of the detection target based on the orthogonal component signals.

### (Appendix 2)

The rotation angle calculation device according to Appendix 1, wherein
the acquiring unit acquires, as the detection results, a signal U of phase U, a signal V of phase V, and a signal W of phase W, each of which has a phase difference of 120 degrees with each other, and
the generation unit generates an orthogonal component signal X by subtracting the signal V from the signal U, and the orthogonal component signal Y by subtracting twice the signal W from the sum of the signal U and the signal V.

### (Appendix 3)

A rotation angle calculation system including:
the rotation angle calculation device according to Appendix 1 or 2; and
a motor comprising a stator around which windings are wound and a rotor in which the permanent magnet is installed,
wherein each of the three detection elements is positioned at a location where the leakage flux generated by the permanent magnet installed between the stator and the rotor can be detected. Rotation angle calculation system.

### (Appendix 4)

The rotation angle calculation system according to Appendix 3, wherein
each of the three detection elements is positioned, when a length of the permanent magnet in a radial direction of the motor is B, in the radial direction of the motor, from a position three times the distance B away from one terminal of the permanent magnet to a position three times the distance B away from the other terminal of the permanent magnet.

### (Appendix 5)

The rotation angle calculation system according to Appendix 4, wherein
each of the three detection elements is positioned, in an axial direction of the motor, within three times the distance B away from a terminal of the permanent magnet.

### (Appendix 6)

The rotation angle calculation system according to Appendix 5, wherein
each of the three detection elements is positioned, in the axial direction of the motor, within the range of the windings wound around the stator.

### (Appendix 7)

The rotation angle calculation system according to Appendix 3, wherein
each of the three detection elements is positioned, when a length of the permanent magnet in an axial direction of the motor is B, in the axial direction of the motor, from a position three times the distance B away from one terminal of the permanent magnet to a position three times the distance B away from the other terminal of the permanent magnet.

### (Appendix 8)

The rotation angle calculation system according to Appendix 7, wherein
each of the three detection elements is positioned, in a radial direction of the motor, within three times the distance B away from a terminal of the permanent magnet.

### (Appendix 9)

The rotation angle calculation system according to any one of Appendices 3 to 8, wherein
a length M of the permanent magnet in an axial direction of the motor is represented by S+2A≤M≤1.3S, where S is a length of the stator in the axial direction of the motor, and A is a length of a gap in a radial direction of the motor between the permanent magnet and the stator.

### (Appendix 10)

The rotation angle calculation system according to any one of Appendices 3 to 9, wherein
each of the three detection elements is positioned between windings wound around the stators adjacent in a circumferential direction of the motor.

### (Appendix 11)

A rotation angle calculation method including:
acquiring detection results of a leakage flux generated by a permanent magnet, from each of three detection elements, the permanent magnet being included in a detection target of the rotation angle, the three detection elements being arranged at positions offset by 120 degrees from each other in electrical angle relative to the permanent magnet;
generating orthogonal component signals, each of the orthogonal component signals representing one of two orthogonal components representing the strength of the leakage flux, based on the three detection results; and
calculating the rotation angle of the detection target based on the orthogonal component signals.

### (Appendix 12)

A rotation angle calculation program causing at least one processor to perform:
acquiring detection results of a leakage flux generated by a permanent magnet, from each of three detection elements, the permanent magnet being included in a detection target of the rotation angle, the three detection elements being arranged at positions offset by 120 degrees from each other in electrical angle relative to the permanent magnet;
generating orthogonal component signals, each of the orthogonal component signals representing one of two orthogonal components representing the strength of the leakage flux, based on the three detection results; and
calculating the rotation angle of the detection target based on the orthogonal component signals.

What is claimed is:

1. A rotation angle calculation system comprising:
a rotation angle calculation device that calculates a rotation angle of a detection target; and
a motor comprising a stator around which windings are wound and a rotor in which a permanent magnet is installed, wherein
the rotation angle calculation device comprises:
an acquisition unit that acquires detection results of a leakage flux generated by a permanent magnet, from each of three detection elements, the permanent magnet being included in a detection target of the rotation angle, the three detection elements being arranged at positions offset by 120 degrees from each other in electrical angle relative to the permanent magnet;
a generation unit that generates orthogonal component signals, each of the orthogonal component signals representing one of two orthogonal components representing the strength of the leakage flux, based on the three detection results; and
a calculation unit that calculates the rotation angle of the detection target based on the orthogonal component signals, and wherein
each of the three detection elements is positioned at a location where the leakage flux generated by the permanent magnet installed between the stator and the rotor can be detected, and
a length M of the permanent magnet in an axial direction of the motor is represented by S+2A≤M≤1.3S, where S is a length of the stator in the axial direction of the motor, and A is a length of a gap in a radial direction of the motor between the permanent magnet and the stator.

2. The rotation angle calculation system according to claim 1, wherein
the acquiring unit acquires, as the detection results, a signal U of phase U, a signal V of phase V, and a signal W of phase W, each of which has a phase difference of 120 degrees from each other, and
the generation unit generates an orthogonal component signal X by subtracting the signal V from the signal U, and the orthogonal component signal Y by subtracting twice the signal W from the sum of the signal U and the signal V.

3. The rotation angle calculation system according to claim 1, wherein
each of the three detection elements is positioned, when a length of the permanent magnet in a radial direction of the motor is B, in the radial direction of the motor, from a position three times the distance B away from one terminal of the permanent magnet to a position three times the distance B away from the other terminal of the permanent magnet.

4. The rotation angle calculation system according to claim 3, wherein
each of the three detection elements is positioned, in an axial direction of the motor, within three times the distance B away from a terminal of the permanent magnet.

5. The rotation angle calculation system according to claim 4, wherein
each of the three detection elements is positioned, in the axial direction of the motor, within the range of the windings wound around the stator.

6. The rotation angle calculation system according to claim 1, wherein
each of the three detection elements is positioned, when a length of the permanent magnet in an axial direction of the motor is B, in the axial direction of the motor, from a position three times the distance B away from one terminal of the permanent magnet to a position three times the distance B away from the other terminal of the permanent magnet.

7. The rotation angle calculation system according to claim 6, wherein
each of the three detection elements is positioned, in a radial direction of the motor, within three times the distance B away from a terminal of the permanent magnet.

8. A rotation angle calculation system comprising:
a rotation angle calculation device that calculates a rotation angle of a detection target; and
a motor comprising a stator around which windings are wound and a rotor in which a permanent magnet is installed, wherein
the rotation angle calculation device comprises:
an acquisition unit that acquires detection results of a leakage flux generated by a permanent magnet, from each of three detection elements, the permanent magnet being included in a detection target of the rotation angle, the three detection elements being arranged at positions offset by 120 degrees from each other in electrical angle relative to the permanent magnet;
a generation unit that generates orthogonal component signals, each of the orthogonal component signals representing one of two orthogonal components representing the strength of the leakage flux, based on the three detection results; and
a calculation unit that calculates the rotation angle of the detection target based on the orthogonal component signals, and wherein
each of the three detection elements is positioned at a location where the leakage flux generated by the permanent magnet installed between the stator and the rotor can be detected, and
a length M of the rotor core that is an axial part of the rotor in an axial direction of the motor is represented by S+2A≤M≤1.3S, where S is a length of the stator in the axial direction of the motor, and A is a length of a gap in a radial direction of the motor between the permanent magnet and the stator.

9. The rotation angle calculation system according to claim 1, wherein
each of the three detection elements is positioned between windings wound around the stators adjacent in a circumferential direction of the motor.

10. A rotation angle calculation method comprising:
acquiring detection results of a leakage flux generated by a permanent magnet, from each of three detection elements, the permanent magnet being included in a detection target of the rotation angle, the detection target being a motor comprising a stator around which windings are wound and a rotor in which a permanent magnet is installed, the three detection elements being arranged at positions offset by 120 degrees from each other in electrical angle relative to the permanent magnet;
generating orthogonal component signals, each of the orthogonal component signals representing one of two orthogonal components representing the strength of the leakage flux, based on the three detection results; and
calculating the rotation angle of the detection target based on the orthogonal component signals, and wherein
each of the three detection elements is positioned at a location where the leakage flux generated by the permanent magnet installed between the stator and the rotor can be detected, and
a length M of the permanent magnet in an axial direction of the motor is represented by S+2A≤M≤1.3S, where S is a length of the stator in the axial direction of the motor, and A is a length of a gap in a radial direction of the motor between the permanent magnet and the stator.

11. A non-transitory computer-readable storage medium storing a rotation angle calculation program, the rotation angle calculation program causing at least one processor to perform:
acquiring detection results of a leakage flux generated by a permanent magnet, from each of three detection elements, the permanent magnet being included in a detection target of the rotation angle, the detection target being a motor comprising a stator around which windings are wound and a rotor in which a permanent magnet is installed, the three detection elements being arranged at positions offset by 120 degrees from each other in electrical angle relative to the permanent magnet;
generating orthogonal component signals, each of the orthogonal component signals representing one of two orthogonal components representing the strength of the leakage flux, based on the three detection results; and
calculating the rotation angle of the detection target based on the orthogonal component signals, and wherein
each of the three detection elements is positioned at a location where the leakage flux generated by the permanent magnet installed between the stator and the rotor can be detected, and
a length M of the permanent magnet in an axial direction of the motor is represented by S+2A≤M≤1.3S, where S is a length of the stator in the axial direction of the motor, and A is a length of a gap in a radial direction of the motor between the permanent magnet and the stator.
